(19) United States
(12) Patent Application Publication
(10) Pub. No.: US 2016/0019267 A1
(43) Pub. Date: Jan. 21, 2016

(54) Using data mining to produce hidden insights from a given set of data

(71) Applicant: Icube Global LLC, Jacksonville, FL (US)

(72) Inventors: Kiran Kala, Jacksonville, FL (US); Jonnavithula Suryaprakash, Hyderabad (IN); Kolluru Venkata Dakshina Murthy, Hyderabad (IN)

(21) Appl. No.: 14/802,997

(22) Filed: Jul. 17, 2015

(30) Foreign Application Priority Data
Jul. 18, 2014 (IN) 3552/CHE/2014

(51) Int. Cl. G06F 17/30

(52) U.S. Cl. CPC G06F 17/30539; G06F 17/30572; G06F 17/30569

(57) ABSTRACT

A method and system for using data mining to produce hidden insights from a given set of data. The system reads data, automatically preprocesses the data and generates deep hidden insights based on a preprocessed data. The hidden insights are generated using a suitable combination of at least two of an evolutionary method, a separate and conquer method, and a random subspace method. The system further prioritizes the insights, based on goodness metrics, and generates an optimal list of insights.

### PRIORITY DETAILS

The present application is based on, and claims priority from, Indian Application Number 3552/CHE/2014, filed on 18 Jul. 2014, the disclosure of which is hereby incorporated by reference herein.

### FIELD OF INVENTION

This invention relates to performing data mining on a set of data and more particularly to performing data mining on the set of data to obtain hidden insights.

### BACKGROUND OF INVENTION

In business, data mining is analysis of data, preferably stored in a data warehouse, for gathering information about historical business activities by various users. Business intelligence (BI) and predictive analytics enable business entities to attain information hidden within a large amount of raw data. In BI, data is aggregated and interactively manipulated; whereas in predictive analysis, statistical estimation, tests, modeling and so on are done.

In BI, raw data is transformed into meaningful and useful information using set of techniques and tools for business analysis purposes. This technology helps to identify, develop and create new strategic business opportunities.

In the predictive analysis method, rules are extracted from existing data set to determine patterns and predict future outcomes and trends. It predicts future with acceptable level of reliability, what-if scenarios and risk assessment. In business, predictive models are used to analyze current and past data to understand customers, products and patterns. Predictive analysis also helps to identify potential risks and opportunities of a company. To forecast business, it uses number of techniques such as data mining, statistical modeling, machine learning and so on for analyzing data set. Modern predictive analytic software may provide simplified user interfaces which specify the statistic metrics, interactive features, increased visualization within the output and so on.

Data mining algorithms are used to extract insights or rules or patterns from a set of data. A decision-tree classifier is devised according to the traditional techniques such as Disjunctive Normal Form (DNF) Rules, decision trees, nearest neighbor, support vector machines (SVMs), Bayesian classifiers, Interval Classifier, Induction of Decision Trees and so on, often cannot be expanded in complexity without sacrificing their generalization accuracy. The more complex such classifiers are (as the more tree nodes they have), the more susceptible they are to being over-adapted to, or specialized at, the training data which was initially used to train the classifiers. As such, the generalization accuracy of the more complex classifiers is relatively low as they more likely commit errors in classifying “unseen” data, which may not closely resemble the training data previously “seen” by the classifiers.

In multiple binary decision tree classifiers, each tree is designed based on a different criterion directed to a measure of information gain from the features. The criteria used in the tree design include Komogorov-Smirnov distance, Shannon entropy measure, and Gini index of diversity. Because of a limited number of such criteria available, the number of trees includable in such a classifier is accordingly limited.

The main advantage of nonparametric classification using matched binary decision trees and multiple decision tree methods are that they are simple, understandable, and can be easily be operationalized into enterprise workflow for validation. However, the tree based classification techniques use a maximal conservative approach (greedy search method) with respect to finding insights and suffers from difficulties of inducing disjunctive concepts due to duplication.

A disadvantage of the classification methods such as decision trees and random forests that are currently being used is that they may miss out significant rules. In random forest, random attributes are selected to grow tree. In decision tree, the data set is split into subsets based on the attribute value test. Generally, while generating patterns from a set of data, traditional classification methods output only a few rules using the entire attribute space. However, the search conducted during these methods are global, the method may miss on local search phenomena. Growing global trees by searching huge space renders full-grid searches computationally infeasible.

### STATEMENT OF INVENTION

In view of the foregoing, an embodiment herein provides a method for generating insight from a set of data in an insight generation system. Initially, at least one input to generate said insight is collected by a data analysis engine of said insight generation system. Further, the collected input is pre-processed by said data analysis engine. After pre-processing the input, the insight is generated using at least one of an evolutionary method, a separate and conquer method, and a random subspace method, by said data analysis engine, wherein said insight indicates a useful portion of said at least one input data. The generated insight is then filtered and prioritized by the data analysis engine.

Embodiments further disclose a system for an insight generation system for generating insight from a set of data. The insight generation system collects at least one input to generate said insight, by a data analysis engine of said insight generation system, and pre-processes the input, by said data analysis engine. After pre-processing the input, the data analysis engine generates said insight using at least one of an evolutionary method, a separate and conquer method, and a random subspace method, wherein said insight indicates a useful portion of said at least one input data. The data analysis engine further filters and prioritizes the insight.

These and other aspects of the embodiments herein will be better appreciated and understood when considered in conjunction with the following description and the accompanying drawings.

### BRIEF DESCRIPTION OF FIGURES

This invention is illustrated in the accompanying drawings, throughout which like reference letters indicate corresponding parts in the various figures. The embodiments herein will be better understood from the following description with reference to the drawings, in which:

FIG. 1 depicts a block diagram of an insight generation system, according to embodiments as disclosed herein;

FIG. 2 depicts components of data analysis engine, according to embodiments as disclosed herein;

FIG. 3 is a flowchart illustrating process of insight generation, using the insight generation system, according to embodiments as disclosed herein;

FIG. 4 is a flowchart illustrating process of handling missing value, according to embodiments as disclosed herein;

FIG. 5 is a flowchart illustrating process of attribute-wise data discretization, according to embodiments as disclosed herein;

FIG. 6 is a flowchart depicting steps involved in generation of insights, using a first method, according to embodiments as disclosed herein;

FIG. 7 is a flowchart depicting steps involved in generation of insights, using second method, according to embodiments as disclosed herein;

FIG. 8 is a flowchart depicting steps involved in the process of generating insights, using a third method, according to embodiments as disclosed herein;

FIG. 9 is a flowchart illustrating filtering criteria for insights generated using the third method, according to embodiments as disclosed herein; and

FIG. 10 is a flowchart illustrating process of calculating goodness metrics for prioritizing generated insights, according to embodiments as disclosed herein.

### DETAILED DESCRIPTION OF INVENTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

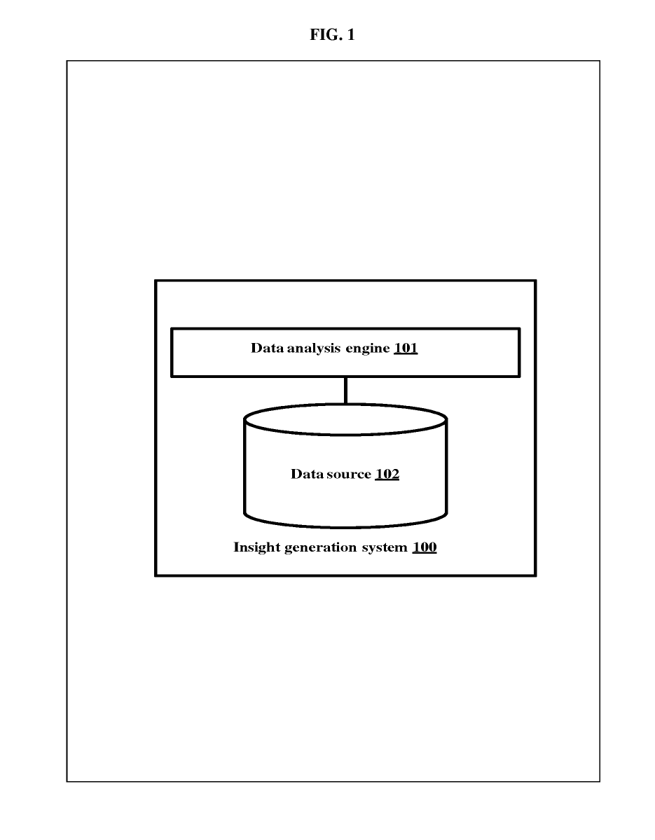

The embodiments herein achieve a method and system that reads data, automatically preprocesses the data, generates deep hidden insights based on the preprocessed data, prioritizes the insights based on goodness metrics and generates an optimal list of insights. Referring now to the drawings, and more particularly to FIGS. 1 through 10, where similar reference characters denote corresponding features consistently throughout the figures, there are shown preferred embodiments.

Embodiments herein disclose a system and method that reads data, automatically preprocesses the data and later generates hidden insights based on the preprocessed data. Also, disclosed herein a method and system that prioritizes the insights based on goodness metrics and generate an optimal list of insights.

The system for insight generation, as disclosed herein, can be configured to automatically preprocess the data which handles missing information and data discretization. The system can be further configured to generate the insights, using a combination of at least three different methods for refining the hidden insights generation process. For example, the system may combine an evolutionary method, a separate and conquer method, and a random subspace of tree based classification approaches, so as to generate the hidden insights. The system may further extract a pattern from the insights and define goodness metrics to prioritize the insights. It is to be noted that the values of different parameters mentioned in the specification can be changed/configured as per requirements. The values mentioned in the equations and examples provided in the specification are not intended to limit the scope in any manner.

FIG. 1 depicts a block diagram of an insight generation system, according to embodiments as disclosed herein. The insight generation system 100 comprises of a data analysis engine 101, and at least one data source 102.

The data analysis engine 101 may be configured to self-learn, based on data processed and insights generated at any instance of time. The insight generation system 100 may be configured to generate insights using data fetched from the data source 102; wherein the insight refers to a useful portion of the input data (i.e. the data being analyzed) that can be used to understand patterns related to at least one aspect of the business and/or users. The insight generation system 100 may be further configured to take insights or hunches from a user, by providing at least one suitable interface for the user to communicate with the insight generation system 100. The insight generation engine 100 may be further configured to validate the collected inputs, retain good rules, convert good rules to hunches, and validate the hunches with time to alert the user and so on.

The data analysis engine 101 may be configured to fetch data from at least one data source 102. The data analysis engine 101 and the data source 102 may be connected to each other using a suitable means such as a wired means, wireless means and so on. The data source 102 may be configured to store database related to functions such as pre-processing of data, generation of insights and prioritization of insights. The database may be such as CRM, HRM, ERP, MS Access, Oracle, MySQL, SQL, Informix and so on. The data source 102 may be configured to store data such as, but not limited to user uploaded data, user grouped attributes, new attributes, business hunches and so on. The data source may be configured to organize data into business understandable groups such as demography, socioeconomic factors and so on. The data source 102 may be further configured to store data which indicates whether an attribute is actionable or not.

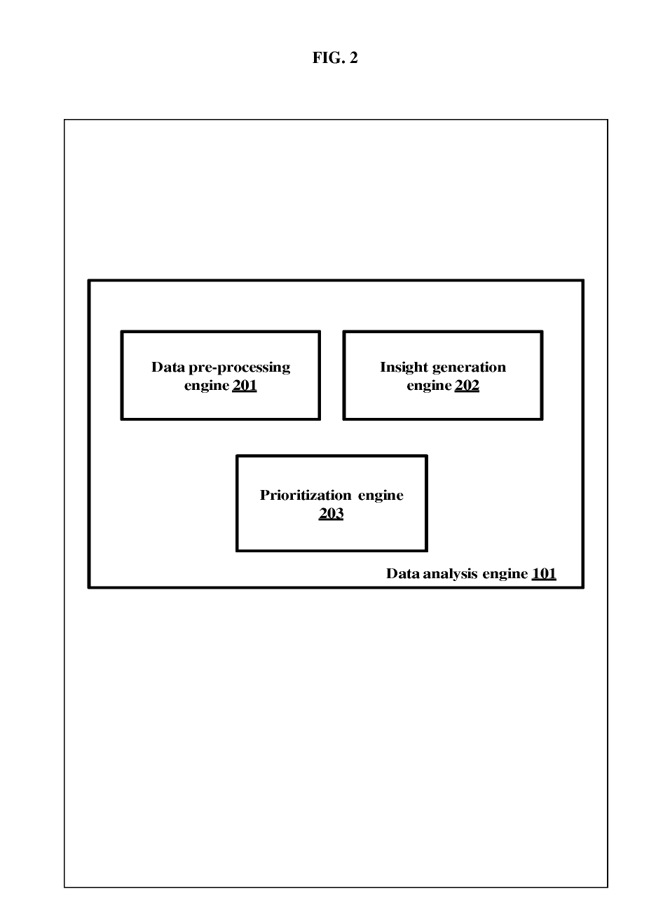

FIG. 2 depicts components of data analysis engine, according to embodiments as disclosed herein. The data analysis engine 101 comprises of a data pre-processing engine 201, an insight generation engine 202, and prioritization engine 203.

The data preprocessing engine 201 preprocesses the data. Preprocessing may comprise of handling missing values and data discretization. The pre-processing engine 201 may be configured to access data source 102 for handling missing values and data discretization. The pre-processing engine 201 may be configured to accept data provided by user through the user interface. In a preferred embodiment, by pre-processing the data, the data analysis engine 201 prepares i.e. converts the data to a format that is suitable for further processing.

The insight generation engine 202 can be configured to collect the pre-processed data as input, and process the collected data further, to generate the insights. The insight generation engine 202 may be configured to generate insights from the data, using at least one or a suitable combination of a first method, a second method, and a third method. The first, second, and third methods are evolutionary method, a separate and conquer method, and a random subspace method respectively. In another embodiment any of the aforementioned methods can be replaced with any other suitable method, as per requirements. The terms ‘first method’ and ‘evolutionary method’ are used interchangeably throughout the specification. The terms ‘second method’ and ‘separate and conquer method’ are used interchangeably throughout the specification. The terms ‘third method’ and ‘random sub-space method’ are used interchangeably throughout the specification. The insight generation engine 202 can be further configured to process together, outputs of each method used to generate the insight, to generate a common insights output, wherein the common output is a refined output, based on at least one pre-defined category.

The prioritization engine 203 may be configured to collect the insights generated by the insight generation engine 202 as input, and prioritize the generated insights by calculating goodness metrics. The prioritization engine 203 can be configured to prioritize the insights using goodness metrics and optimal insights may be obtained. In an embodiment, the prioritization engine 203 calculates the goodness metrics by estimating statistic metrics such as, but not limited to support, confidence, lift, support score, and confidence score. The data analysis engine 101 further stores the insights and corresponding priorities in a suitable location. The suitable location may be the data source 102 or any other data storage means.

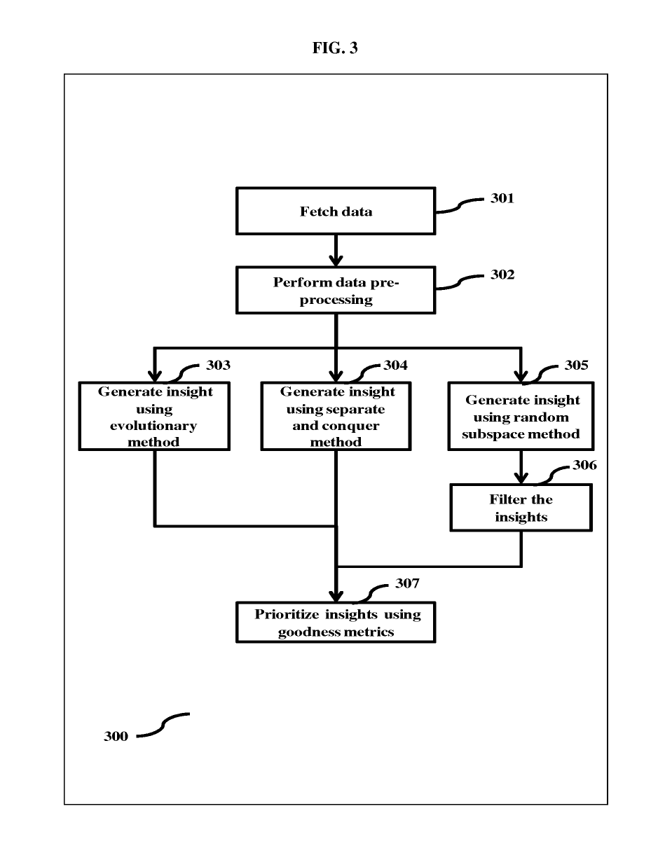

FIG. 3 is a flowchart illustrating process of insight generation, using the insight generation system, according to embodiments as disclosed herein. The data analysis engine 101 fetches (301) at least one data from the data source 102. In an embodiment, the data is fetched from the data source 102, based on at least one criteria pre-configured by the user and/or any authorized personnel. For example, the fetched data may include grouped attributes, new attributes, business hunches and so on, which may be organized into business understandable groups such as demography, socioeconomic factors and so on.

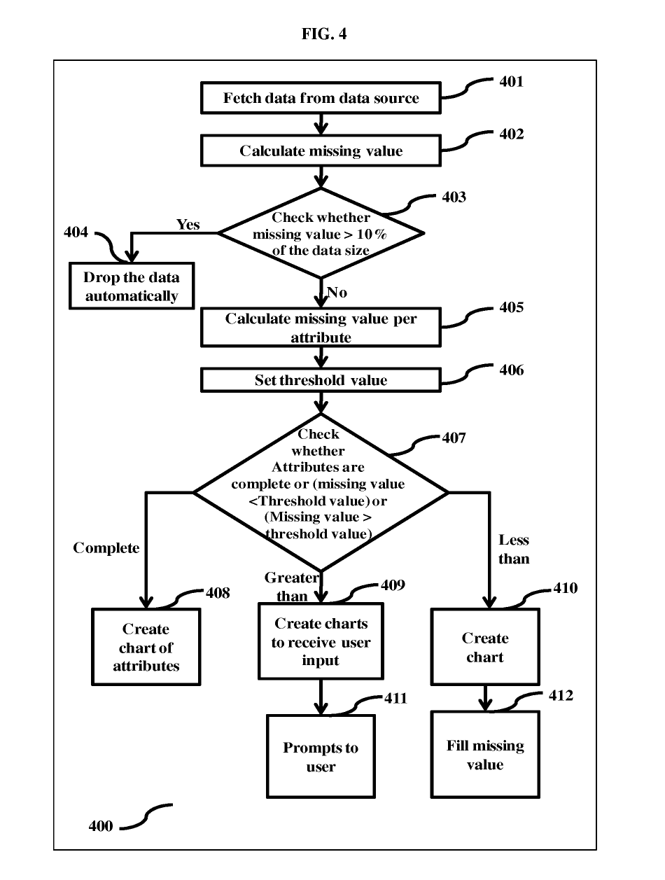

Further, the collected data is preprocessed (302) by the data preprocessing engine 201. Preprocessing may comprise of handling missing values and data discretization. Handling missing values comprises of computing complete values of attribute on the data (as depicted in FIG. 4). If the incomplete values of attributes are greater than a certain percentage, (say 10% of the data size) then corresponding attributes may be automatically dropped by the data preprocessing engine 201. Otherwise the data preprocessing engine 201 may request for further data. The data preprocessing engine 201 further computes the missing values density per attribute and generates output in at least one suitable format. For example, the outputs may be in the form of charts. If the output is in chart form, a first chart displays all the attributes that have complete data, a second chart displays all the attributes that have missing values less than the threshold value, and a third chart displays all the attributes that have missing values more than the threshold value. The data preprocessing engine 201 may automatically use imputation methods to fill the missing values on the attributes with less than the threshold missing values. The data preprocessing engine 201 may prompt the user to upload cleaner data for the attributes where the missing values are more than the threshold value. The data preprocessing engine 201 may finally provide clean data.

Further, all numeric type attributes are picked from the clean data, and discretization is performed on the attributes by the data pre-processing engine 201, to convert the data into a discrete form. The data preprocessing engine 201 recommends the ideal number of bins per attribute. Initially, the data preprocessing engine 201 computes gain ratio for a number of bins (5, 10, 15, 20, 25, 30, and so on) using both equal width and equal frequency method. The data preprocessing engine 201 picks the bin with highest gain ratio and computes the gain ratio of the neighboring bins. In an example, if the highest gain ratio is at 20 then the data preprocessing engine 201 computes the gain ratio of the neighboring bins 17, 18, 19, 21, 22, and 23 and picks the bin with highest gain ratio. Also, if any of the bins have less than 30 records, then the data preprocessing engine 201 automatically merges values with the previous bin. So, the output from this step comprises of the attribute and the corresponding bin structure.

The user may further mark if the attribute is actionable or not. Here, ‘Actionable’ character of an attribute implies the attribute may be used to make decisions. For instance, the user cannot change or make a decision based on an attribute=Gender; whereas for an attribute CampaignMode that has direct, email, phone, pamphlets options can be considered as actionable because the user can modify the options and evaluate the impact.

The data preprocessing engine 201 further checks if the user wants to modify a bin structure, or not. If the user wants to modify the bin structure, the data preprocessing engine 201 enables the user to modify the bin structure. In an example, for the categorical attributes, the data preprocessing engine 201 allows the user to perform merge operations in order to modify the levels within the attribute. After performing the above operations, the data preprocessing engine 201 may save the binning structure, actionability of attributes and so on. After pre-processing the data, the data analysis engine 101 further generates insights by employing the insight generation engine 202, based on the data.

Embodiment disclosed herein generates insights from the data using a combination of three different methods. The method may comprise of evolutionary method (EV), separate and conquer method (PRISM) and random subspace (RSS) method. In an embodiment, the number of methods used for generating the insights can vary, based on requirements. Embodiment disclosed herein uses a hybrid approach wherein the concepts of genetic algorithm and simulated annealing may be used to design the first method. The insight generation engine 202 generates (302, 303, 304) insights using at least one or using a suitable combination of at least two of the first method, second method, and the third method.

The first method generates rules as initial population (chromosomes in genetic algorithm or a number of random samples as in simulated annealing) and generates rules from them using mutation and cross-over process wherein mutation may be defined as the swapping of an attribute in the rule randomly with an unselected attribute and cross-over may be defined as flipping the level of an attribute chosen randomly within the rule. The embodiment uses a variant of simulated annealing and genetic algorithm. It works with a single random sample at a time and perturbs it (like simulated annealing) through swapping the level of the attribute or the attribute itself with an unselected attribute (like in genetic algorithm it has a mutation and cross over operations with different probabilities) and accepts better solutions all the time and accept worser solutions probabilistically (like in simulated annealing). The rules may be shortlisted based on a fitness function wherein the fitness function may be defined such that the current generated rules are more accurate when compared to previous set of rules. The rule which qualify the fitness function may become part of the next process.

The second method recursively breaks data set into multiple spaces and generates rules. The rules generated from multiple spaces are combined to generate rules for the entire set of data.

The third method uses the greedy approach to find rules locally for a given subspace. The third method uses a tree based classification namely. The third method receives inputs such as the number of records and the number of attributes. To avoid duplication of subspaces in this method the number of trees, subspace, uncorrelated trees and how to pick the best insights from these are determined while designing the conditions.

Embodiment disclosed herein describes a filter for filtering the insights generated using the third method. The insight generation engine 202 filters (306) the insights generated by the third method using the data from the data source 102. In a preferred embodiment, the insights are filtered based on at least one pre-configured filtering rule such as but not limited to Goodness, Actionability, and Explicability. A filtering option, from the web application perspective, may reduce the waiting time of user to obtain rules generated without compromising on the quality of rules.

Quality of a rule may be determined by calculating support, confidence and lift of each rule. A quality rule may have the support that is greater than or equal to minimumSupport, confidence that is greater than minimum confidence and lift that is greater than one.

The prioritization engine 203 prioritizes (307), at least three insights that may be generated by combination of the three methods used, using the data from the data source 102, employing goodness metrics. The insights may be prioritized using goodness metrics and optimal insights may be obtained. The goodness metrics of a generated rule is calculated considering support score, confidence score and normalized lift score of the rule. The rule having goodness metric greater than or equal to the rule score may be considered as an optimal rule and saved to the insight generation system 100.

Once the insights are generated, the data analysis engine 101 further prioritizes the insights using a suitable technique such as Harmonic Mean (HM), actionability, non-triviality and so on. The data analysis engine 101 determines the actionability score as follows:

Length of insight=# of conditions in the antecedent

Act_count=number of actionable attributes in the antecedent

Act_insight=Act_count/Length of insight

The data analysis engine 101 may use non-triviality to measure how explicable the insight is. Number of conditions in the antecedent of the insight is indirectly proportional to the explicability of the insight. More the conditions in the antecedents less are the explicability of the insight and hence the non-triviality score, and vice versa.

Non-triviality score=round(1.1765*exp(−0.163*attributeCount),2)

With these metrics, based on the business value, either all or one of these metrics can be considered to assess the priority of the insight. The data analysis engine 101 further stores the insights and corresponding priorities in a suitable location.

The various actions in method 300 may be performed in the order presented, in a different order or simultaneously. Further, in some embodiments, some actions listed in FIG. 3 may be omitted.

FIG. 4 is a flowchart illustrating the process of handling missing values, according to embodiments as disclosed herein. Embodiments disclosed herein enable auto-filling of missing values that are less than the threshold value per attribute. The data pre-processing engine 201 fetches (401) data from at least one data source 102. The data may be uploaded by the user to the database. The data stored in the data source 102 may comprise of user uploaded data, user grouped attributes, new attributes, business hunches entered by user and so on. The data may also be organized into business understandable groups such as demography, socioeconomic factors and so on. The data pre-processing engine 201 then calculates (402) the percentage of missing value per attribute considering the entire attribute space.

The data pre-processing engine further checks (403) whether the size of missing value of data is greater than 10% of the data size; wherein the 10% value is pre-configured, and can be re-configured as per requirements. If the size of missing value of data is greater than 10% of the data size, the data pre-processing engine 201 drops (404) the data automatically. If the size of missing value of data is less than the data size, then the data pre-processing engine 201 calculates (405) percentage of missing values per attribute. The data pre-processing engine 201 sets (406) a threshold value for missing value of data.

The data pre-processing engine 201, then checks (407) if attributes in the entire space has complete values or percentage of missing value per attribute is greater than threshold value or percentage of missing value per attribute is lesser than threshold value. If there are no missing values in attributes, then the data pre-processing engine 201 creates (408) a chart of attributes which has complete values in each attribute. If there are more missing values than the threshold value per attribute, then the data pre-processing engine 201 may create (409) a chart of missing value to receive user input and prompts (411) the user to drop the attribute. In an embodiment, if the number of missing values is more than the threshold value, then the user may be provided an option to update the input with clean data. The user may input data using the input chart created by the data pre-processing engine 201. If lesser values are missing compared to the threshold value, then the data pre-processing engine 201 creates (410) a chart of missing values and fills (412) the missing values by means of imputation method.

During imputation, missing values of different attributes may be replaced with a probable value based on values in similar class of other attributes. Initially, set aside attributes that may have missing values lesser than the threshold value. Next the following steps may be carried out on the remaining data for imputation:

1. If the attribute type is numeric, then discretize using equal frequency into 5 bins each.
2. Calculate the gain ratio of all the attributes and pick top 3 attributes based on gain ratio.
3. Create data subsets (buckets) as mentioned below:
a. Subset data based on top 1 & 2 attributes, obtain complete values of these attributes
b. Each time take a combination of levels of both the attributes
c. For each combination, take the subset/bucket and check for the class distribution.
   i. If the target class levels is more than 95% in the subset then treat it as one single bucket and carry out imputation.
   ii. Else, subset data further based on number of target lass levels
d. Now do global imputation target lass wise in each bucket and repeat this for all attribute-level combinations and set is aside.
   4. The step should be repeated for all the following attribute combinations and further by attribute-level and class to perform imputation.
   5. in case, some values of attribute are still missing then apply global imputation.

Embodiments disclosed herein do not introduce bias in the data and mislead the modeling outcomes. The method disclosed above is quick, subsets data based on attributes which have high gain ratio, further subsets based attribute-level pair and target class level and then performs simple central imputation; method to replace missing values.

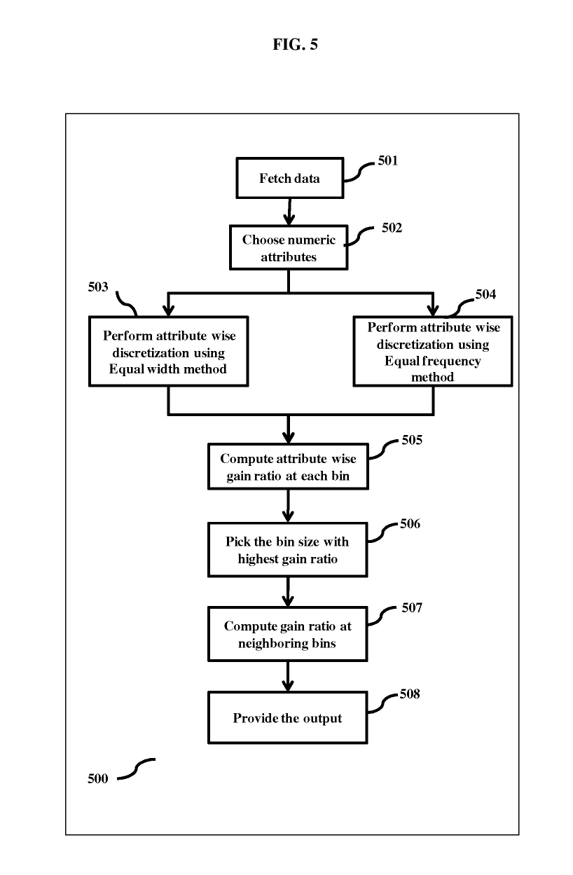

FIG. 5 is a flowchart illustrating the process of attribute wise data discretization, according to embodiments as disclosed herein.

The data pre-processing engine 201 fetches (501) data from the data source 102 and picks (502) the numeric type attributes from the data. The data pre-processing engine 201 recommends the ideal number of bins per attribute.

Initially, the data analysis engine 101 computes (503, 504) gain ratio for a number of bins (5, 10, 15, 20, 25, 30, and so on) using both equal width and equal frequency method. The data pre-processing engine 201 computes (505) the attribute wise gain ration at each bin. The data pre-processing engine picks (506) the bin with highest gain ratio and computes (507) the gain ratio of the neighboring bins. For example, if the highest gain ratio is at 20 then the data analysis engine 101 computes the gain ratio of the neighboring bins 17, 18, 19, 21, 22, and 23 and picks the bin with highest gain ratio. Also, if any of the bins have less than 30 records, then the data pre-processing engine 201 automatically merges values with the previous bin. In an embodiment, the number of records (i.e. 30 in the aforementioned example) can be varied according to the requirements, by providing at least one option for the user to configure the value.

The data pre-processing engine 201 provides (508) the output, wherein the output comprises of the attribute and the corresponding bin structure. The various actions in method 500 may be performed in the order presented, in a different order or simultaneously. Further, in some embodiments, some actions listed in FIG. 5 may be omitted.

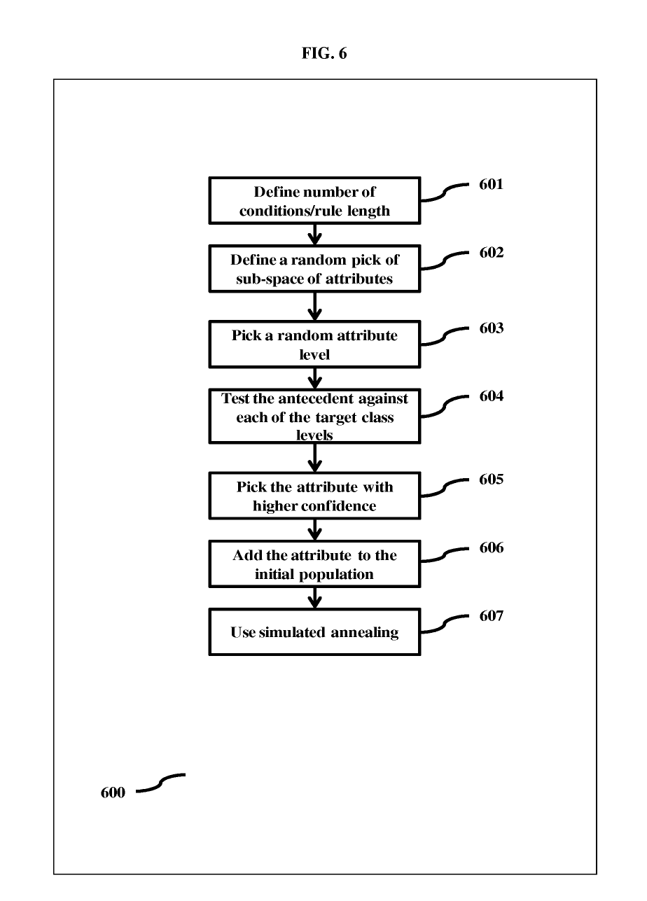

FIG. 6 is a flowchart illustrating steps involved in insight generation using first method, according to embodiments as disclosed herein. Initially, the insight generation engine 202 defines and creates an initial population from which insights are generated. For this, the insight generation engine 202 defines (601) a number of conditions such as the rule length by picking a random number and further defines (602) random pick of the sub-space of attributes. Then, the insight generation engine picks (603) attribute-level at random for the selected attribute.

The insight generation engine 202 tests (604) the antecedent for all levels of target attribute and picks (604) the attribute that has higher confidence on the data. The insight generation engine 202 adds (606) the attribute to the initial population. The insight generation engine 202 searches the entire space randomly to generate rules, it might occur that a rule may not exist but it may be retained so as to generate better rules by mutation and cross-over in later steps.

The stopping criterion of the number of rules in the initial population may be defined by default as follows. The user can change these.

3.33*No. of quality rules from C5.0

Now, the initial population may be 3.33*No. of quality rules from C5.0 and if C5.0 failed to give any quality rules then the initial population may be minimum of below 2 options.

0.1*No. of rows in dataset, or

10*No. of columns in dataset, or

The fitness function may be defined as the confidence of the new insight should be greater than or equal to that of initial insight or there is no change in the insight until 10 consecutive iterations. The insight retained in this step may be used to generate next set of insights using mutation and cross-over conditions.

The newly added attributes to the initial population may not retain the original from the class rather the class level with highest confidence for that rule is assigned.

The insight generation engine 202 may use (607) the simulated annealing method with defined mutation criteria and acceptance criteria to generate and retain best insights. Mutation criteria and acceptance criteria together may form the control parameters to find best insights from the initial population of insights.

The insight generation engine 202, sets the initial probability for mutation and cross-over as equal and the cross-over probability decreases linearly for the first 50 iterations and then exponentially decreases for the next 50 iterations. For the first 50 iterations, the mutation probability may be calculated using the formula:

Mutation Probability=Initial Probability−0.005*i

Where ‘i’ is the iteration number and initial probability is 0.5.
For iterations from 51 to 100, the mutation probability is calculated from the formula

Mutation Probability=Mutation Probability (in Previous iteration)/1.2

### Where;

‘i’ is the iteration number.
The cross-over probability is 1−Mutation Probability.

For each iteration, the insight generation engine 202 may compare the confidence of the rule to the confidence of the original rule, before mutation/cross-over. If the confidence of the rule after mutation/cross-over is greater than original rule, that rule may be accepted for the next iteration. But if the confidence is less than before, the rule is accepted with a probability which may be defined as:

$$Acceptance Probability - \frac{1}{100 * c * i}$$

### Where;

c is the change in the confidence and
i is the iteration number

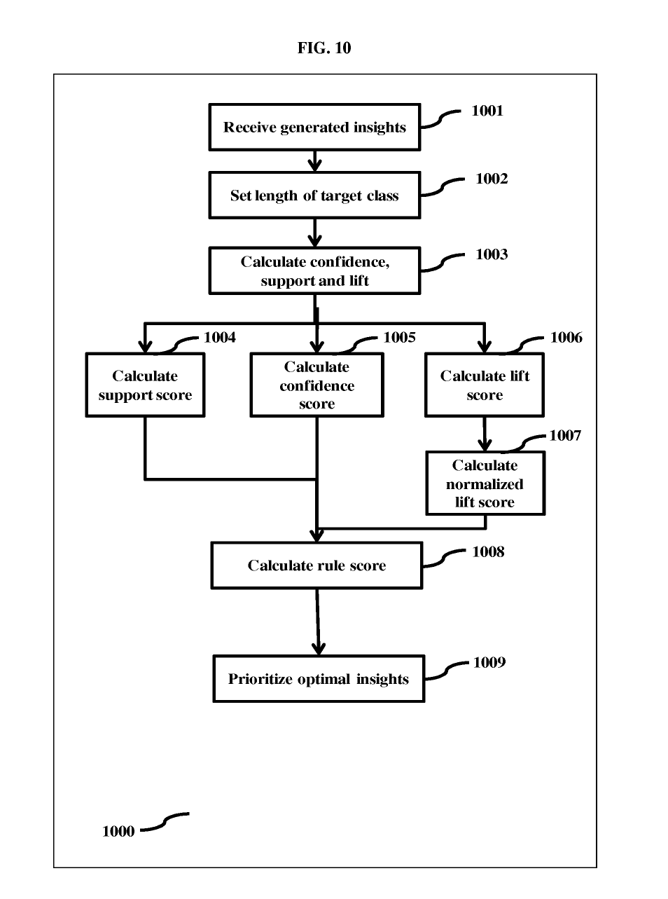

The insight generation engine 202 provides the generated insights. The generated insights may be prioritized using goodness metrics (described in FIG. 10) and generate an optimal list of insights which can be saved.

The various actions in method 600 may be performed in the order presented, in a different order or simultaneously. Further, in some embodiments, some actions listed in FIG. 6 may be omitted.

The pseudo-code for the first method is as follows (with FIG. 6 being the corresponding flow chart):

Read the control parameters of the algorithm

```
Generation = 1
  Initial population:
  Random number of antecedents between 1 and 6 for a rule;
  Random sub-space of attributes
  For each selected attribute, randomly pick a level for the attribute
  Max_generation: {0.1 * # rows in dataset, or 10 * # columns in
  dataset, or 3 * # quality rules from C5.0}
While generation ≦max_generation do
Evaluate the fitness of all insights
Find best insights
For i = 1 to 100 do
Perform mutation
  For the first 50 iterations,
  MutationProbability = InitialProbability - 0.005 * i; (i=iteration
  number, initial probability = 0.5)
  For iterations from 51 to 100:
  MutationProbability = MutationProbability(inPreviousiteration)/1.2
Perform cross-over
  Cross-over probability = 1 - Mutation Probability.
Endfor
Copy the new insight into the new population
Reproduce the best parent into the random slot
Check for convergence of new population
While the acceptance probability holds do
Reproduce the best insight
Regenerate other insights randomly
Endwhile
Generation = generation +1
Endwhile
```

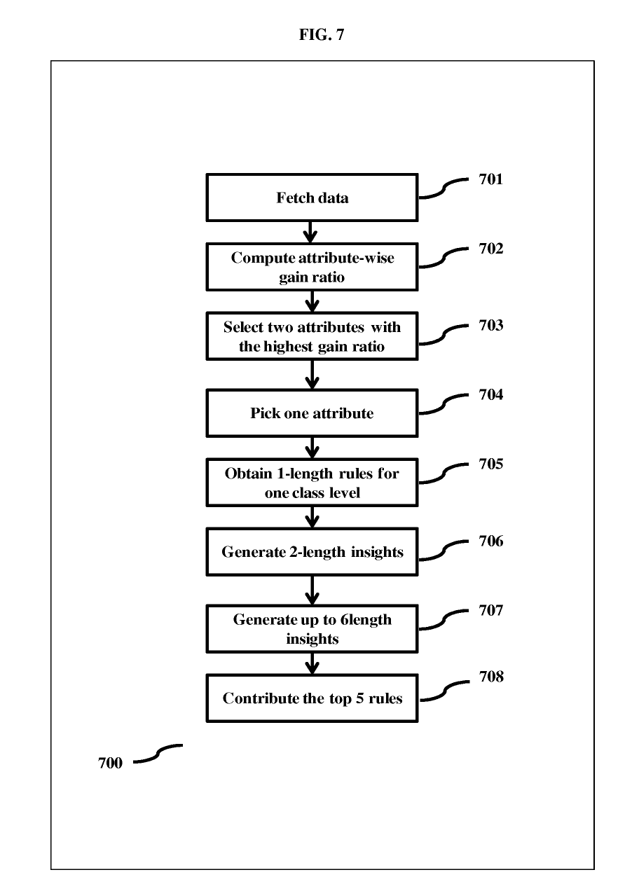

FIG. 7 is a flowchart illustrating steps involved in insight generation using the second method, according to embodiments as disclosed herein. The objective of this approach herein is to extract the top ‘n’ insights having high confidence where the number of conditions in the antecedent will range in 1-6 at each target class level. Initially, the insight generation engine 202 fetches (701) data from the data source 102 and computes (702) attribute wise gain ratio and selects (703) two attributes with the highest gain ratio. The insight generation engine 202 picks (704) one attribute.

The insight generation engine 202 further obtains (705) all possible 1-length rules for one class level by creating an attribute-level combination as the antecedent for one target class level and doing the same for all other 4 attributes as well. The insight generation engine 202 further generates (706) 2 length insights by first computing confidence for all the 1 length rules and selecting the top 5 rules with high confidence. If the top 5 insights all have 100% confidence then the top 5 rules that have less than 100% confidence are considered. The insight generation engine 202 further generates (706) 3-length insights by reading the 2-length insights one after other. The insight generation engine 202 obtains a subset of data which satisfies the rule by applying each rule on the dataset.

The insight generation engine 202 computes the gain ratio on this subset of data. The insight generation engine 202 considers the top 2 attributes with high gain ratio as a second condition in the antecedent. The insight generation engine 202 adds each new rule generated here to the antecedents of the existing insight to get all possible 3-length rules. At all the stages, the insight generation engine 202 takes the top 5 insights with high confidence for generating next level insights. The above process is repeated (707) till the data analysis engine 101 gets 6-length rules (6 conditions in the antecedent of the rule). The insight generation engine 202 contributes (708) the top 5 rules from every level (1-length, 2-length . . . 6-length) to the rule basket. In an example, if the target class variable in the dataset has n-levels, then the total rules are 30*n.

If the top 5 rules of a level (n-length rules) all have 100% confidence, then the insight generation engine 202 may not be able to generate higher length rules as all the data points satisfying the LHS of the rule are of same class and the entropy is zero. In such a case, the top 5 rules with high confidence but less than 100% are taken for generating higher length rules.

The insight generation engine 202 may take rules with high but <100% confidence to generate higher length rules but finally, the top 5 rules with high confidence (including 100%) from each level (n-length) form the final set of rules.

The various actions in method 700 may be performed in the order presented, in a different order or simultaneously. Further, in some embodiments, some actions listed in FIG. 7 may be omitted.

The pseudo-code for the second method is as follows (with FIG. 7 being the corresponding flow chart):

```
Compute gain ratio attribute wise, order based on descending order of the gain ratio, select
top 2 attributes
For each attribute, create attribute-level combination as the antecedent for one target class
level.
All the possible 1-length rules for one Class level.
  Compute confidence for all the 1-length rules, and select 5 rules with highest
  confidence
  If top 5 rules have 100% confidence then retain them and look for next top 5
  rules in order to generate next length rules.
  Subset: Apply each generate rule on the dataset for a subset of data which the
  rule satisfies. Compute gain ratio on this subset, and select top 2 attributes with
  high gain ratio to generate all possible rules.
  Add new attributes to the antecedents of the existing insight
  Compute confidence of all insights, and select the top 5 insights which have
  greater than minimum confidence in order to generate 2-length rules.
Repeat the process until 6-length rules (6 conditions in the antecedent of the rule) are
obtained
The top 5 rules from every level (1-length, 2-length....6-length) form part of the rule basket.
```

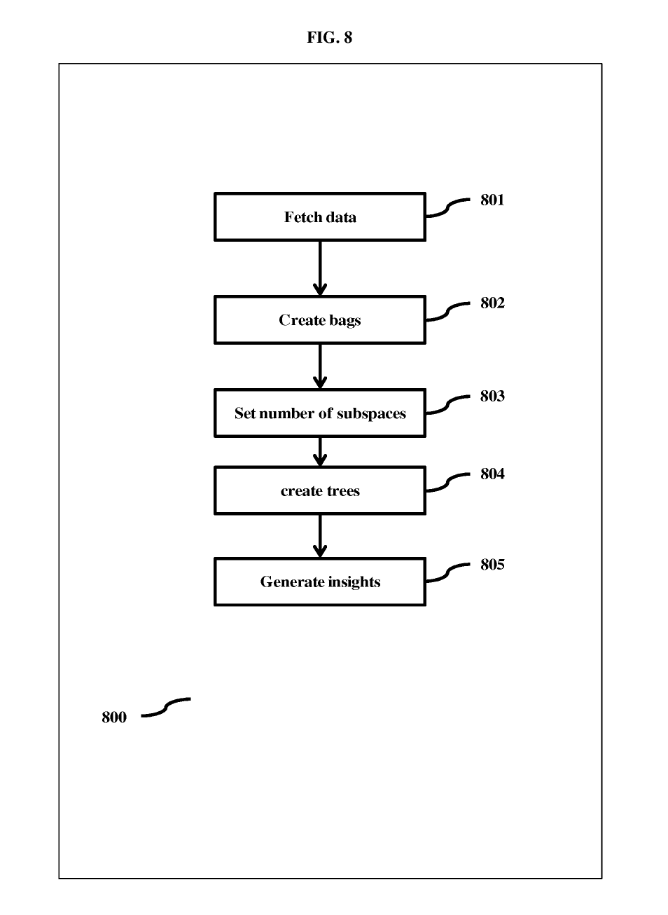

FIG. 8 is a flowchart illustrating steps involved in insight generation using the third method, according to embodiments as disclosed herein. The third method may use a tree based classification method. The main inputs to this approach are the number of records, the number of attributes. There are several parameters that determine the robustness of this approach. Parameters may comprise of determining the number of trees, subspaces and so on.

Initially, the insight generation engine 202 fetches (801) data from the data source 102. The insight generation engine 202 creates (802) subspaces for searching rules. The insight generation engine 202 sets (803) the number of subspaces for searching rules. The insight generation engine 202 sets (804) the trees. The insight generation engine 202 generates (805) rules from the trees. The process of generations of trees and their rules will stop when the number of rules generated by this method reaches 3.33*number of the quality rules generated by C50

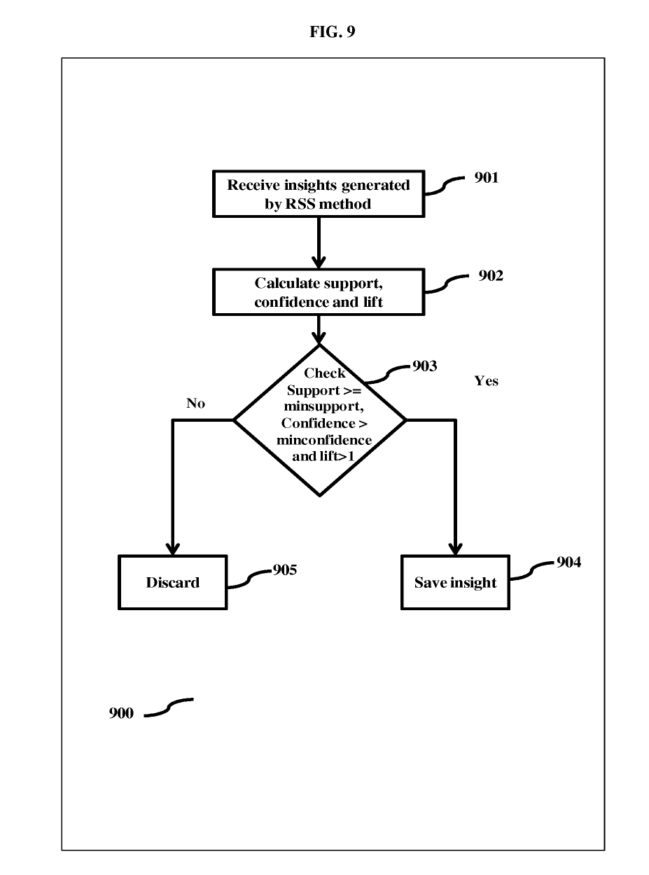

The rules may be generated in tree structure using C 5.0 algorithm by using the third method. The process of generating rules may be repeated for the number of subspaces set by the insight generation engine 202. The insights generation engine 202 provides the insights generated, further the insight generation engine 202 may filter the insights generated using a filtering criteria (described in FIG. 9)

The various actions in method 800 may be performed in the order presented, in a different order or simultaneously. Further, in some embodiments, some actions listed in FIG. 8 may be omitted.

The pseudo-code for the third method is as follows (with FIG. 9 being the corresponding flow chart):

Input: Data dimension (# of records (N), # of attributes(n)),
# of trees (t), Subspace)
Subspace: n′ ≦n
# of trees: t
t = # of times the C5.0 algorithms has to run (Total number of subspaces)
If n >6 then t =min (500, nC₆)
Bag: Subspace definition
If n >6 then n′ = 6
Insights aggregation
Now train C5.0 model and get the insights out of the tree
Number of iterations = t
Number of insights (rules) = K
If K >0 then save these output details
else
read the next combination of subspace until all ‘t’ or until the required
number of insights are extracted whichever is earlier.
Only those insights that qualify the conditions will be part of the rule basket.
Obtain the Rules/Pattern extraction
Compute the support, confidence and lift of each insight and add
them to the rule basket.

FIG. 9 is a flowchart illustrating filtering criteria for insights generated using the third method, according to embodiments as disclosed. Embodiment disclosed herein describes a filter for filtering the insights generated by the third method. A filtering option, from the web application perspective, may reduce the waiting time of user to obtain rules generated without compromising on the quality of rules. The prioritization engine 203 receives (901) the insight generated by the third method from the data source 102.

Further, the prioritization engine 201 calculates (902) support, confidence and lift of each rule. Then, the prioritization engine 203 checks (903) whether the support is greater than or equal to minimumsupport, confidence is greater than minimum confidence and lift is greater than 1 in insights set. A quality rule may have the support that is greater than or equal to minimumSupport, confidence that is greater than minimum confidence and lift that is greater than one. If an insight is determined to be a quality rule then, the prioritization engine saves (904) the filtered insight, else the prioritization engine 201 discards (905) the insight.

For example, if the C5.0 algorithm has generated 500 rules, then on applying the filtering criteria mentioned below to the rules may provide rules that have satisfied the criteria These rules become the quality rules from C5.0 and can be saved by the prioritization engine 202:
Filtering Criteria:
MinimumSupport: (30 records, 10% of the records of the data for that corresponding target class level)/Number of records in the entire data. In an embodiment, the number of records can be re-configured as per requirements.
MinimumConfidence: 1/p, where p=number of target class levels
MinimumLift: Lift>1

A quality rule should have the Support that is greater than or equal to MinimumSupport, Confidence that is greater than Minimum Confidence and Lift that is greater than one in hidden insights set.

After applying the above filter, the number of rules has reduced to say 100, then eventually the number of rules generated by other methods will also be reduced and hence the time taken to generate the rules may be reduced. Based on the above filtering criteria, statistically significant/quality rules may be identified from C5.0. The stopping criteria of the three methods may generate at least as many as 3.3 times of the quality C5.0 rules. Thus, the above procedure reduces the waiting time of the user as well as generates numerous significant rules.

The various actions in method 900 may be performed in the order presented, in a different order or simultaneously. Further, in some embodiments, some actions listed in FIG. 9 may be omitted.

FIG. 10 is a flowchart illustrating process of calculating goodness metrics for prioritizing insights, according to embodiments as disclosed herein. The prioritization engine 203 receives (1001) the insights. The insights received may comprise of rules generated using a combination of the three methods.

The prioritization engine 203 sets (1002) the length for target class of the attributes of a rule. The prioritization engine 203 calculates (1003) support, confidence and lift for each rule within the set length of class.

The prioritization engine 203 calculates (1004) supportscore of the rules. The equation used to calculate supportscore may be:

SupportScore<=[−(Support*log 2(Support))−((1−Support)*(log 2(1−Support)))]

The prioritization engine 203 calculates (1005) confidencescore of the rules.

The equations used to calculate confidencescore may be:

If (Confidence<=(1/p), then confidecenscore=0,

If Confidence>1/p then confidencescore=confidence

### Where;

p=length(Target Class_{AllLevels})

The prioritization engine 203 calculates (1006) liftscore of the rules. The equations used to calculate liftscore may be:

LiftScore=log 2(Lift) (do the min-max normalization on this)

The prioritization engine 203 calculates (1007) normalized liftscore of the rules. The equations used to calculate normalizedliftscore may be;

NormalizedLiftScore<=[LiftScore−min(LiftScore)]/[max(LiftScore)−min(LiftScore)]

The prioritization engine 203 calculates (1008) rulescore of the rules. The equations used to calculate rulescore may be:

IntuceoRuleScore<=[(SupportScore²)+(ConfidenceScore²)+(NormalizedLiftScore²)]

The prioritization engine 203 prioritizes (1009) the optimal insights according to the rulescore of the insights. The various actions in method 1000 may be performed in the order presented, in a different order or simultaneously. Further, in some embodiments, some actions listed in FIG. 10 may be omitted.

Embodiments herein use the terms ‘insights’, ‘rules’ and ‘patterns’ interchangeably.

The methods discussed herein overcome the problem of getting caught at the sub optimum solution and find deep insights.

Embodiments disclosed herein provide an improvement over existing methods by automatically handling both categorical and numeric attributes and generate insights that provide a holistic approach to search the hypothesis space and pick the best insights.

Embodiments disclosed herein use evolutionary methods such as genetic algorithm and simulated annealing. These are popular as they leap the hypothesis space and drop randomly hence do not suffer the problem of local optima and hence discover global optimum. Embodiments disclosed herein define the subspaces and determining the best insight for a given subspace rather than entire space.

Embodiments disclosed herein use a separate and conquer approach also known as covering algorithm. It generates insights directly from data by reading the examples covered by each class. At each stage the rule is identified that covers some of the examples then these examples are skipped from consideration for the next rules and thus avoid duplication to induce rules extensively.

Embodiments herein disclose an ensemble approach that builds tree based classifiers on several subspace of attributes and outputs insights.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

1. A method for generating insight from a set of data in an insight generation system, said method comprising:
collecting at least one input to generate said insight, by a data analysis engine of said insight generation system;
pre-processing said at least one input, by said data analysis engine;
generating said insight using at least one of an evolutionary method, a separate and conquer method, and a random subspace method, by said data analysis engine, wherein said insight indicates a useful portion of said at least one input data;
filtering said generated insight, by said data analysis engine; and
prioritizing said insight, by said data analysis engine.

2. The method as claimed in claim 1, wherein pre-processing said at least one input further comprises of:
handling at least one missing value in said at least one input, by said data analysis engine; and
converting said at least one input to a discrete format, using at least one discretization procedure, by said data analysis engine.

3. The method as claimed in claim 2, wherein handling said at least one missing value further comprises of:
calculating amount of missing values in a pre-processed input, by said data analysis engine;
dropping said at least one data if said amount of missing values exceeds a first threshold value, by said data analysis engine; and
presenting said at least one input to a user, in at least one suitable format, by said data analysis engine.

4. The method as claimed in claim 2, wherein converting said at least one input to said discrete format further comprises of:
choosing at least one numeric attribute from a pre-processed input, by said data analysis engine;
discretizing said pre-processed input, based on at least one attribute-wise discretization procedure, by said data analysis engine;
determining attribute-wise gain ratio, by said data analysis engine;
determining gain ratio in at least one neighboring node, by said data analysis engine; and
displaying at least one output, by said data analysis engine, wherein said output comprises of at least one attribute and a corresponding bin structure.

5. The method as claimed in claim 1, wherein filtering said generated insight further comprises of:
determining value of at least one of a support, confidence, and lift, pertaining to said insight, by said data analysis engine;
comparing said determined value of said at least one of the support, confidence, and lift with corresponding threshold values, by said data analysis engine;
saving said insight, if said determined value of at least one of said support, confidence, and lift exceeds corresponding threshold value, by said data analysis engine; and
discarding said insight, if said determined value of at least one of said support, confidence, and lift is less than corresponding threshold value, by said data analysis engine.

6. The method as claimed in claim 1, wherein said insight is prioritized based on a rulescore pertaining to said insight, by said data analysis engine.

7. An insight generation system for generating insight from a set of data, said insight generation system configured for:
collecting at least one input to generate said insight, by a data analysis engine of said insight generation system;
pre-processing said at least one input, by said data analysis engine;
generating said insight using at least one of an evolutionary method, a separate and conquer method, and a random subspace method, by said data analysis engine, wherein said insight indicates a useful portion of said at least one input data;
filtering said generated insight, by said data analysis engine; and
prioritizing said insight, by said data analysis engine.

8. The insight generation system as claimed in claim 7, wherein said data analysis engine is configured for pre-processing said at least one input by:
handling at least one missing value in said at least one input, by a data pre-processing engine of said data analysis engine; and
converting said at least one input to a discrete format, using at least one discretization procedure, by said data pre-processing engine.

9. The insight generation system as claimed in claim 8, wherein said data pre-processing engine is configured to handle said at least one missing value by:
calculating amount of missing values in a pre-processed input, by said data pre-processing engine;
dropping said at least one data if said amount of missing values exceeds a first threshold value, by said data pre-processing engine; and
initiating a secondary action if said amount of missing values is less than said first threshold value, by said data pre-processing engine.

10. The insight generation system as claimed in claim 8, wherein said data pre-processing engine is configured to convert said at least one input to said discrete format by:
choosing at least one numeric attribute from a pre-processed input, by said data pre-processing engine;
discretizing said pre-processed input, based on at least one attribute-wise discretization procedure, by said data pre-processing engine;
determining attribute-wise gain ratio, by said data pre-processing engine;
determining gain ratio in at least one neighboring node, by said data pre-processing engine; and
displaying at least one output, by said data pre-processing engine, wherein said output comprises of at least one attribute and a corresponding bin structure.

11. The insight generation system as claimed in claim 7, wherein said data analysis engine is configured to filter said generated insight by:
determining value of at least one of a support, confidence, and lift, pertaining to said insight, by an insight generation engine of said data analysis engine;
comparing said determined value of said at least one of the support, confidence, and lift with corresponding threshold values, by said insight generation engine;
saving said insight, if said determined value of at least one of said support, confidence, and lift exceeds corresponding threshold value, by said insight generation engine; and
discarding said insight, if said determined value of at least one of said support, confidence, and lift is less than corresponding threshold value, by said insight generation engine.

12. The insight generation system as claimed in claim 7, wherein data analysis engine is configured to prioritize said insight, based on a rulescore pertaining to said insight.
